(19) United States
(12) Patent Application Publication
(10) Pub. No.: US 2026/0166688 A1
(43) Pub. Date: Jun. 18, 2026

(54) LASHING TOOL

(71) Applicant: The Hand Safety Tool Company, LLC, Missouri City, TX (US)

(72) Inventors: Christopher Ryan Lee, Missouri City, TX (US); Jonathan Ricardo Montoya, Houston, TX (US)

(21) Appl. No.: 19/419,388

(22) Filed: Dec. 15, 2025

Related U.S. Application Data
(60) Provisional application No. 63/734,430, filed on Dec. 16, 2024.

(51) Int. Cl. B25B 13/50; B25B 23/00

(52) U.S. Cl. CPC B25B 13/50; B25B 23/0007

(57) ABSTRACT

A tool includes an elongate rigid shaft having a first end and a second end, wherein the first end of the shaft forms a first connector element. The tool further includes a fork having a base section, first and second prongs extending distally from the base section, and a second connector element formed with the base section. The second connector element is configured to form a mating connection with the first connector element, wherein the first and second connector elements have complementary non-circular circumferential profiles configured for one of the connector elements to fit closely within another of the connector elements and prevent angular deflection and axial rotation between the connector elements.

### BACKGROUND

The present disclosure relates to a tool for manipulating a lashing bar turnbuckle, such as those used on a container ship.

### BACKGROUND OF THE RELATED ART

A turnbuckle is a mechanical device used to adjust the tension or length of a system of ropes, cables, or other tensioning elements. The main components of a turnbuckle are one or more threaded bodies connected by crossbars and two threaded end fittings, which can be hooks, eyes, or jaws. One end fitting has a right-hand thread, and the other has a left-hand thread. This opposing threading allows simultaneous tightening or loosening of both ends by rotating the central body. To operate a turnbuckle, it is first connected to the elements that need tension, such as a rope or cable, by attaching the end fittings. Rotating the central body of the turnbuckle in a clockwise direction about an axis of the turnbuckle pulls the threaded end fittings inward, shortening the effective length of the turnbuckle and increasing tension. Conversely, rotating the central body of the turnbuckle in a counterclockwise direction about the axis of the turnbuckle extends the threaded end fittings outward, reducing tension. Once the desired tension is achieved, the turnbuckle may be secured using locknuts or safety pins to prevent unintentional loosening during use. This simple yet effective mechanism makes turnbuckles essential in construction, rigging, and transportation industries.

A lashing bar turnbuckle is a crucial component in securing cargo, particularly in marine and shipping applications. The lashing bar turnbuckle consists of a central threaded body with two ends, typically fitted with hooks, jaws, or eyes, which are connected to lashing bars or other securing points. The lashing bar turnbuckle's primary function is to adjust and maintain tension in the lashing system, ensuring cargo remains stable during transit. Proper operation requires aligning the turnbuckle with the lashing bar and securing it firmly to avoid slippage. Once tightened to the desired tension, the lashing bar turnbuckle should be checked to ensure it is locked and secure, often using a safety clip or locknut to prevent accidental loosening. This ensures reliable performance even under dynamic loading conditions.

On a container ship, a set of lashing bar turnbuckles are used to secure shipping containers together and ensure their stability during transit. These systems typically involve long steel lashing bars that connect the corner castings of stacked containers to fixed points on the ship's deck and/or adjacent containers. The lashing bar turnbuckles are attached to the ends of the lashing bars and are used to tighten the assembly. To secure the containers, the lashing bars are hooked or attached to designated corners of the containers, and the lashing bar turnbuckles are adjusted by rotating their central bodies to apply tension. This creates a tight, secure connection that resists the forces of wind, waves, and ship movement. By using multiple lashing bars and associated lashing bar turnbuckles strategically, the container stacks are stabilized, reducing the risk of shifting or toppling under dynamic sea conditions.

### BRIEF SUMMARY

Some embodiments provide a tool comprising an elongate rigid shaft having a first end and a second end, wherein the first end of the shaft forms a first connector element. The tool further comprises a fork having a base section, first and second prongs extending distally from the base section, and a second connector element formed with the base section. The second connector element is configured to form a mating connection with the first connector element, wherein the first and second connector elements have complementary non-circular circumferential profiles configured for one of the connector elements to fit closely within another of the connector elements and prevent angular deflection and axial rotation between the connector elements.

### BRIEF DESCRIPTION OF THE SEVERAL VIEWS OF THE DRAWINGS

FIGS. 1A-B are perspective and exploded perspective views of a tool for manipulating a lashing bar turnbuckle according to a first embodiment.

FIGS. 2A-B are top and exploded top views of the tool according to the first embodiment.

FIGS. 3A-B are side and exploded side views of the tool according to the first embodiment.

FIG. 4A is A Side View Of A Turnbuckle.

FIG. 4B is a perspective view of the tool in position to manipulate a lashing bar turnbuckle using a first end effector of the tool in the form of a fork.

FIG. 4C is a perspective view of the tool in position to manipulate a lashing bar turnbuckle using a second end effector of the tool in the form of a paddle.

FIG. 5 is a manufacturing diagram of the tool identifying some preferred dimensions according to one embodiment.

FIG. 6 is a diagram showing the ends of four storage containers and twelve lashing bar turnbuckles being used to secure the four storage containers.

FIGS. 7A-C are perspective views of a tool for manipulating a lashing bar turnbuckle according to a second embodiment.

FIG. 7D is a proximal end view of a socket formed in the fork according to the second embodiment.

FIG. 7E is an end view of a shaft to be received into the socket formed in the fork according to the second embodiment.

FIGS. 8A-B include a side assembly view and a fully assembled side view of the tool according to the second embodiment.

FIGS. 9A-C are cross-sectional views illustrating the stepwise formation of a connection between the fork and the shaft according to the second embodiment.

FIGS. 10A-B are side and perspective views of a proximal end of the shaft including an optional hook feature according to some embodiments.

### DETAILED DESCRIPTION

Some embodiments provide a tool comprising an elongate rigid shaft having a first end and a second end, wherein the first end of the shaft forms a first connector element. The tool further comprises a fork having a base section, first and second prongs extending distally from the base section, and a second connector element formed with the base section. The second connector element is configured to form a mating connection with the first connector element, wherein the first and second connector elements have complementary non-circular circumferential profiles configured for one of the connector elements to fit closely within another of the connector elements and prevent angular deflection and axial rotation between the connector elements.

The tool is a hand tool that is used manually by a person to manipulate turnbuckles, such as lashing bar turnbuckles on container ships or similar applications. More particularly, the tool may be used to turn a lashing bar turnbuckle in a first rotational direction to loosen the turnbuckle (i.e., lessen the amount of tension in the lashing bar turnbuckle) or in a second rotational direction to tighten the turnbuckle (i.e., increase the amount of tension in the lashing bar turnbuckle).

The elongate rigid shaft provides leverage to a user of the tool. With either the fork or a paddle (described later) engaging the turnbuckle, a user may push or pull the elongate rigid shaft to cause rotation of the turnbuckle. For example, the user may apply a force on the elongate rigid shaft that is generally perpendicular to the axis of the elongate rigid shaft. More leverage is obtained when the force is applied to the tool at a greater distance from the turnbuckle. For example, a user may apply the force to an end of the elongate rigid shaft that is opposite of the fork or paddle. However, workspace may be limited by various factors, including the presence of other workers or the spacing between rows of containers. According to one option, the elongate rigid shaft may be between 1 and 3 feet long and the entire tool (i.e., the shaft, fork and any paddle or other feature or end effector) may be between about 2 about 4 feet long.

In some embodiments of the tool, the elongate rigid shaft, the fork and any paddle or other end effector are machined from aircraft grade aluminum. For example, the aircraft grade aluminum may be 7075-T6 grade aluminum or similar material. The benefits of this material are corrosion resistance, high tensile strength, ductility, toughness, and fatigue resistance. However, the tool may be made with other rigid materials, composites or assemblies having many similar properties.

An end effector is a component or attachment that is connected to an end of the elongate rigid shaft and is designed to securely engage the turnbuckle. In embodiments having first and second end effectors, the first end effector and/or the second end effector may be adapted for securely engaging a turnbuckle. The elongate rigid shaft provides a handle for controlling the positioning of one or the other of the end effectors to engage a turnbuckle and also provides leverage for turning the turnbuckle. In some applications, the turnbuckle is a lashing bar turnbuckle on a container ship.

In some embodiments, the first end effector and/or the second end effector are each independently selected from a plurality of end effector types. In other words, the tool may be configured with modular components that support the use of different end effectors and/or different shafts as needed.

In some embodiments, the first and second connector elements include a socket and a plug. In one option, the plug may be axially inserted into the socket and secured within the socket using a fastener that extends laterally through a side wall of the socket and into a side of the plug. In another option, the plug may be axially inserted into the socket and secured within the socket using a fastener that extends axially through a distal end of the socket and into a distal end the plug. Without limitation, the fastener may be a pin, rivet, screw or bolt and nut.

In some embodiments, each of the first and second ends of the elongate rigid shaft may form a first connector and the first and second end effectors, such as a fork and paddle, may have a second connector that is selectively securable to the first connector at either the first end or the second end of the elongate rigid shaft. For example, the first connector may be a socket (or plug), and the second connector may be a plug (or socket) that is selective received in the socket. The plug preferably fits snuggly within the socket to limit or prevent articulation or deflection between the elongate rigid shaft and the end effector. In one option, either of the end effectors may be detached from an end of the elongate rigid shaft and replaced with a different type or size of end effector that is then attached to the end of the elongate rigid shaft. The first and second end effectors may be the same or different.

In some embodiment, the tool may further comprise a hook positioned at the second end of the shaft. The hook may be configured as an attachable end effector with a connector element that connects to the end of the elongate rigid shaft or the hook may be an integral hook formed into the end of the elongate rigid shaft. In one option, the hook may be configured to pull a lever or perform a task other than tightening or loosening of a turnbuckle.

In some embodiments, the fork may have first and second prongs and a slot between the prongs. The slot should have a depth (i.e., distance from the tip of the prongs to the base of the fork) that is sufficient to receive both crossbars of a turnbuckle. However, prongs that are much longer than necessary for the slot to receive both crossbars (i.e., the wide dimension of the turnbuckle body) may interfere with rotation or turning of the turnbuckle. Specifically, prongs extending beyond the turnbuckle may hit against an adjacent turnbuckle or the wall of a container. The slot should also have a width (i.e., distance of the space between the inner surfaces of the two prongs) that allows the prongs to be placed along the sides of the turnbuckle crossbars (i. e, along the narrow dimension of the turnbuckle body), but only with a central axis of the slot generally aligned with a centerline between the two turnbuckle crossbars. In other words, the fork may engage a turnbuckle with one prong extending along a first side of the two turnbuckle crossbars and another prong extending along an opposing second side of the two turnbuckle crossbars. Once the fork engages the turnbuckle in this manner, the width of the slot does not allow any significant rotation of the turnbuckle within the slot before the inward-facing surface of the first and second prongs engage the turnbuckle crossbars. In other words, the width of the slot should only be slightly wider than the narrow dimension of the turnbuckle body. The first and second prongs preferably have inward-facing surfaces that are textured to resist slipping when engaging opposing sides of the turnbuckle crossbars. After the prongs are in contact with the turnbuckle crossbars, further rotation of the tool causes the turnbuckle body to rotate. Rotation in a first direction about a central axis of the lashing bar turnbuckle will cause a shortening of the turnbuckle that adds tension to the lashing bar, whereas rotation in a second direction about the central axis of the lashing bar turnbuckle will cause a lengthening of the turnbuckle that reduces tension in the lashing bar.

The fork is adapted for securely engaging and rotating the turnbuckle body of the turnbuckle and the elongate rigid shaft forms a lever for turning the turnbuckle body under load. In other words, a high tension force in the turnbuckle makes it difficult to turn the turnbuckle body and the length of the elongate rigid shaft provide much needed leverage to enable turning the turnbuckle either for tightening or loosening the turnbuckle. The first and second prongs of the fork preferably has a length extending from the base section that is greater than a width of a space between the first and second prongs. Furthermore, the width of the space or slot between the first and second prongs should be greater than a narrow profile dimension of the turnbuckle body and the length of the first and second prongs from the base section should be greater than a wide profile dimension of the turnbuckle body. In some embodiments, the first and second prongs will receive the turnbuckle body into the space or slot therebetween only when a lateral axis extending from one turnbuckle crossbar to the other turnbuckle crossbar is aligned with a central axis of an opening into the space between the first and second prongs. Once the turnbuckle body has been received between the first and second prongs, rotation of the fork about the axis of the turnbuckle causes the first and second prongs to bear on the outside of the turnbuckle body and causes rotation of the turnbuckle body.

In some embodiments, the tool may include a paddle positioned at the second end of the elongate rigid shaft, wherein the paddle is adapted for positioning between a pair of turnbuckle crossbars of a turnbuckle. With the paddle positioned between the pair of turnbuckle crossbars, rotation of the paddle about the axis of the turnbuckle causes the paddle to bear on the inside of the turnbuckle crossbars and causes rotation of the turnbuckle body. As before, the elongate rigid shaft forms a lever that reduces the amount of force necessary to turn the turnbuckle body. In one option, the paddle includes first and second opposing surfaces that may form a concave recess. A preferred concave recess is an arc having an axis that is perpendicular to the axis of the elongate rigid shaft. The thickness of the paddle must be less than the distance between the turnbuckle crossbars such that the paddle may be inserted between the turnbuckle crossbars. The paddle may be rotated slightly before engaging the turnbuckle crossbars, but further rotation of the tool about the axis of the turnbuckle causes rotation of the turnbuckle. The paddle may be used to rotate the turnbuckle in the first direction and/or the second direction as desired. In another option, the first and second opposing surface of the paddle are textured to resist slippage resistance when engaged between a pair of turnbuckle crossbars.

The primary difference between using the paddle-type end effector and the fork-type end effector is that the paddle is insertable between the turnbuckle crossbars whereas the fork may be positioned with the prongs along the sides of the turnbuckle crossbars. It is a technical benefit of some embodiments of the tool that a user may have a single tool with two end effectors, such that the user may select to use one or the other of the end effectors based upon the accessibility of the turnbuckle in any given situation. For example, a user may approach one lashing bar turnbuckle and decide to use the fork, then proceed to another lashing bar turnbuckle and decide to use the paddle.

In some embodiments, the elongate rigid shaft, the fork, paddle or other end effector may include a set or series of through-holes therein. In one example, the elongate rigid shaft may include a series of through-holes along an axial length of the elongate rigid shaft. In another example, the base section of the fork or the paddle may include a least one through-hole. These holes reduce the overall weight of the tool while allowing the components to retain the required structural strength. For example, the holes may be round, oval or other shapes leaving enough material therearound to maintain the strength of the component. In one option, the tool may further comprise a carrying strap having first and second loops secured through two of the through-holes in the elongate rigid shaft.

In some embodiments, the elongate rigid shaft includes first and second opposing flat side faces that are parallel and the fork includes first and second opposing flat side faces that are parallel. Where the elongate rigid shaft includes a series of through-holes along an axial length of the elongate rigid shaft, the series of through-holes may each extend through the elongate rigid shaft perpendicular to the first and second opposing flat side faces. Still, the elongate rigid shaft includes opposing lateral edges extending between the first and second opposing flat side faces, wherein the opposing lateral edges may each have a convex curved profile. The convex curved profile may fit smoothly in the curve of a user's hand or fingers that are apply a pulling or pushing force on the elongate rigid shaft. It should be appreciated that the opposing lateral edges that form the convex curved profiles face into the direction in which the user will apply a force.

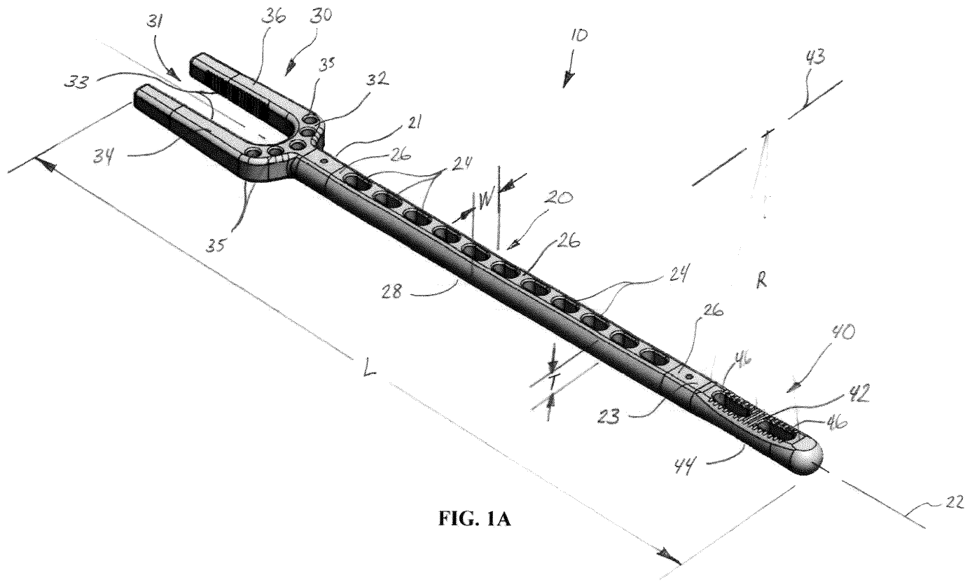

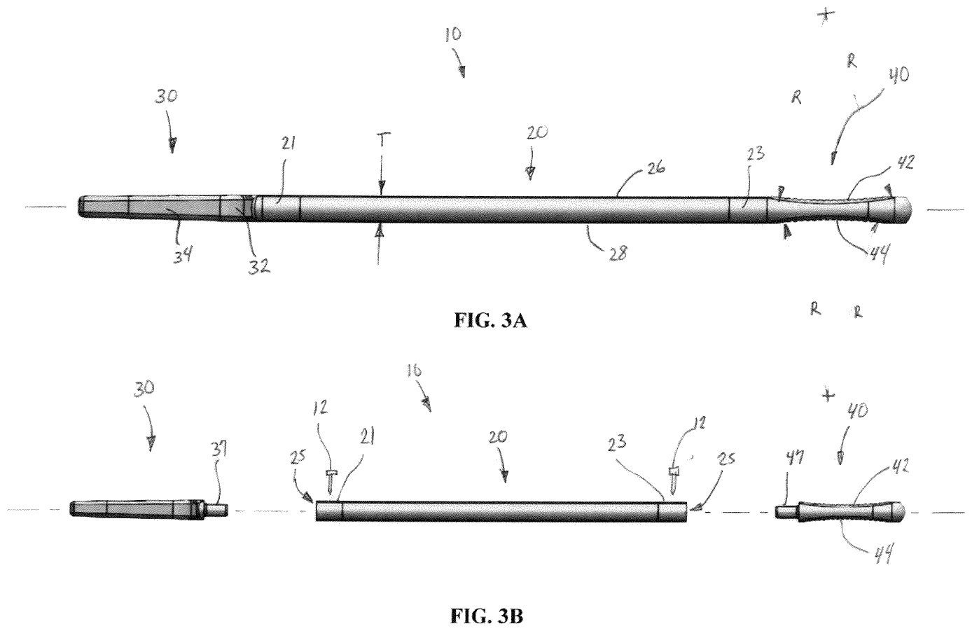

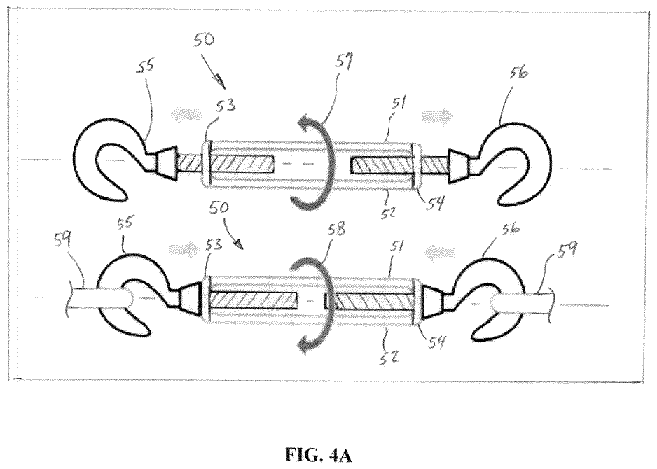

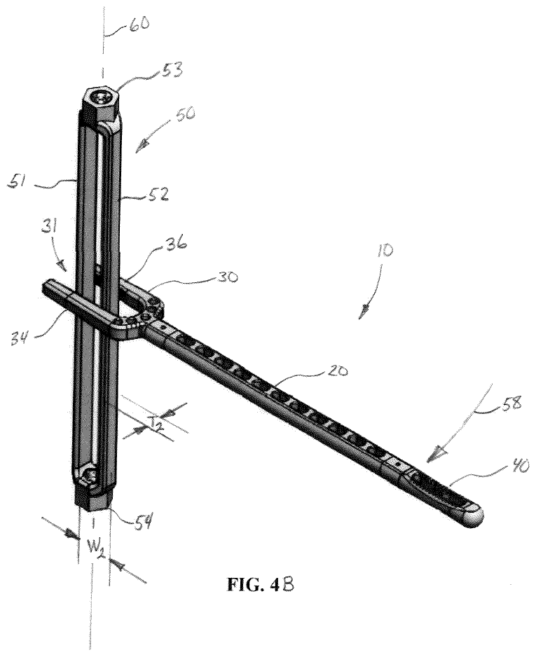

FIGS. 1A-B are perspective and exploded perspective views of a tool or tool assembly 10 for manipulating a lashing bar turnbuckle (not shown; but see FIGS. 4A-C) according to one embodiment. The tool 10 includes an elongate rigid shaft 20, a fork 30 on a first end of the shaft 20 and a paddle 40 on a second end of the shaft 20. The tool 10 is shown having an overall length (“L”). The elongate rigid shaft 20 has a central axis 22, a first end 21 and a second end 23. The elongate rigid shaft 20 is shown with an optional series of holes 24 (11 elongate holes shown). The elongate rigid shaft 20 is also shown having an optional flattened top face 26 and an optional identical flattened bottom face 28 parallel to the top face 26. The lateral edges between the top and bottom faces 26, 28 have a curved convex profile.

The fork 30 is connected to the first end 21 of the shaft 20. The fork 30 includes a base member 32 that connects to the shaft 20, a first prong 34 extending distally from the base section or member 32, and a second prong 36 extending distally from the base section 32. The space between the first and second prongs 34, 36 forms a slot or space 31 for receiving the crossbars of a turnbuckle. In one option, the first and second prongs 34, 36 have inwardly facing surfaces 33 that are textured and/or coated to increase their grip (i.e., slip resistance) when contacting the turnbuckle crossbars. In another option, the base section 32 includes a set of holes 35 (5 holes shown) extending through the base member from the top surface to the bottom surface.

The paddle 40 is connected to the second end 23 of the shaft 20. The paddle 40 may have similar width (“W”) and thickness (“T”) dimensions as the shaft 20. A first (top) surface 42 has a concave recess or arced profile that is generally defined as having a constant radius (“R”) about an axial line 43 that is perpendicular to the central axis 22 of the shaft 20. In a preferred option, the first surface 42 is also textured to increase its grip (i.e., slip resistance) when contacting the turnbuckle crossbars. Independently, the first surface 42 may also include holes 46. Furthermore, the opposing second (bottom) surface 44 may be identical or symmetrical to the first surface 42.

When the fork 30 is engaged with a turnbuckle, a user may rotate the turnbuckle by applying a rotational force to the second end 23 of the shaft 20 and/or the second end effector 40. Conversely, when the paddle 40 is engaged with a turnbuckle, the user may rotate the turnbuckle by applying a rotational force to the first end 21 of the shaft 20 and/or the fork 30.

FIG. 1B is an exploded perspective view of the tool 10. In this view, the first and second ends 21, 23 of the shaft 20 are shown to have a socket 25. Furthermore, the fork 30 has a plug 37 and the paddle 40 has a plug 47. The plugs 37, 47 are interchangeably connectable to the socket 25 at either end of the shaft 20. Accordingly, inserting the plugs 37, 47 into respective sockets 25 of the shaft 20 allows the configuration of the tool 10 as shown in FIG. 1A. Preferably, a fastener such as a pin or screw 12 may be secured through the wall of the socket and into the plug.

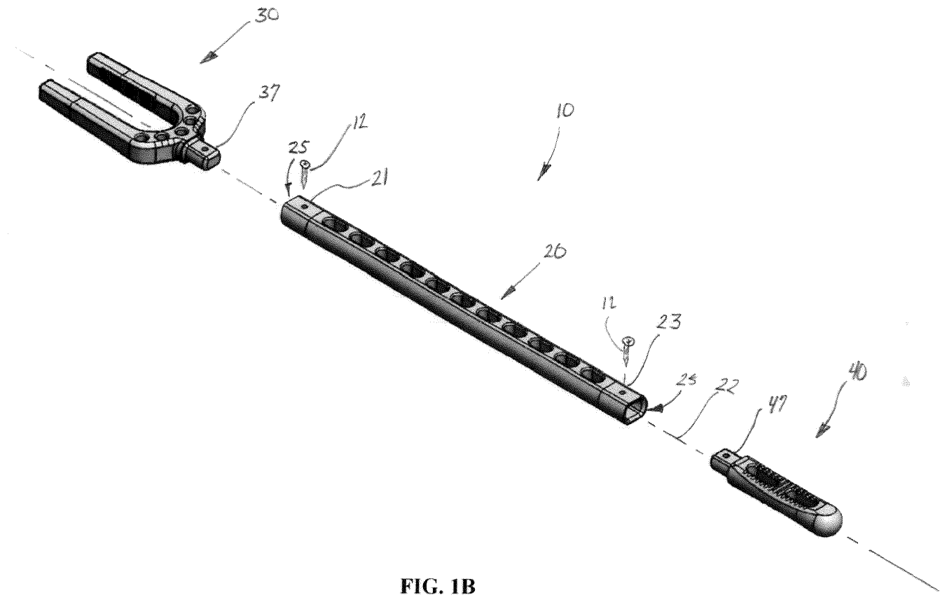

FIGS. 2A-B are top and exploded top views of the tool 10. The same reference numbers as used in FIG. 1 are used in FIGS. 2A-B and other Figures herein to refer to the same parts. However, the top view of FIG. 2A better illustrates the holes 24 in the shaft 20, the holes 35 in the base of the fork 30, and the holes 46 in the paddle 40. The top view also better illustrates the texture on the inward facing surfaces 33 of the prongs 34, 36. An optional narrowing of the width of each individual prong 34, 36 can also be seen with increasing distance from the base 32.

FIG. 2B emphasizes the alignment of the sockets 25 in the opposing ends of the shaft 20 with the plug 37 of the first end effector (fork) 30 and with the plug 47 of the second end effector (paddle) 40. It should be noted that, if a user desired, the user could reconfigure the tool 10 with two paddle-type end effectors 40 or with two fork-type end effectors 30. Yet other end effectors, such as a hook, may be utilized for the same task of installing or removing lashing bar turnbuckles or for some other related tasks.

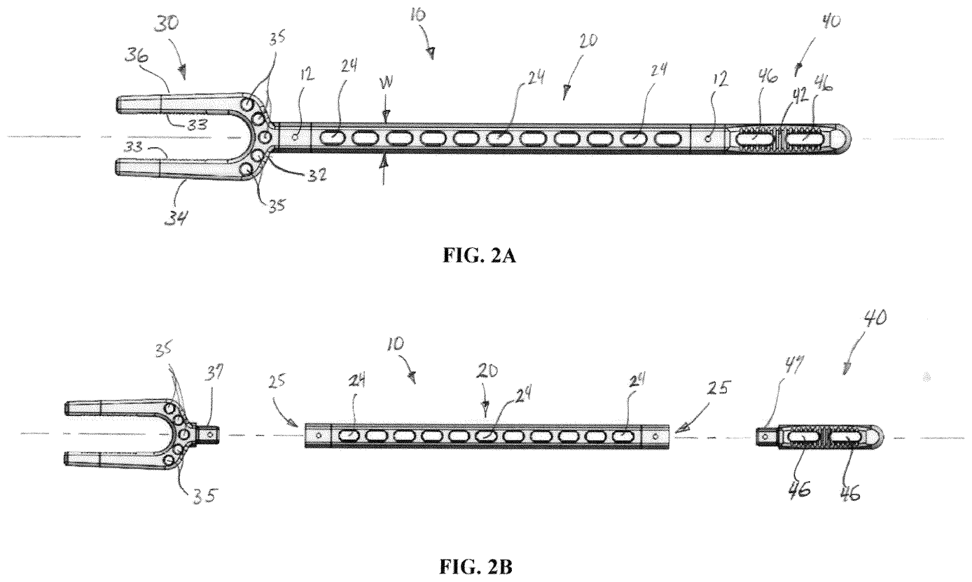

FIGS. 3A-B are side and exploded side views of the tool 10. The top surface 26 and the bottom surface 28 of the tool 10 are shown to be flat. In FIG. 3A, the radius (“R”) of curvature to the recessed surfaces 42, 44 is highlighted. In a further option, the thickness (“T”) of the individual prongs 34, 36 may decrease slightly with increasing distance from the base 32. FIG. 3B emphasizes much of the same relationships as discussed in reference to FIG. 2B but also illustrates the fasteners 12 aligned for securing the plugs 37, 47 within the sockets 25. For example, a threaded fastener 12 may pass through a hole in the sidewall of the socket 25 and into a threaded hole in a respective one of the plugs 37, 47.

FIG. 4A is a side view of two identical turnbuckles 50. Each turnbuckle 50 includes a first crossbar 51, a second crossbar 52, a first internally threaded nut or member 53, and a second internally threaded nut or member 54. The first threaded nut or member 53 is physically secured to a second threaded nut or member 54 at a fixed distance by the first crossbar 51 and the second crossbar 52. Each turnbuckle 50 also includes a first externally threaded fitting 55 and a second externally threaded fitting 56. In FIG. 4A, the first externally threaded fitting 55 has left handed threads that are engaged with corresponding threads in the first threaded nut or member 53 and the second externally threaded fitting 56 has right handed threads that are engaged with corresponding threads in the second threaded nut or member 54. Each fitting 55, 56 is illustrated with a distal hook, but other connector types may also be used, such as eyes and long bars. This operation may be performed when releasing containers on a container ship following transport so that the individual containers may be offloaded and handled separately.

In the upper illustration within FIG. 4A, rotation of the crossbars 51, 52 in a first rotational direction 57 causes the fittings 55, 56 to move apart. If the turnbuckle 50 was already under tension, then turning the crossbars in the first rotational direction 57 will reduce the tension.

In the lower illustration within FIG. 4A, rotation of the crossbars 51, 52 in a second rotational direction 58 (opposite of the first rotational direction) causes the fittings 55, 56 to move closer together. If the turnbuckle 50 is connected to lashing bars, hooks or other load members 59 as shown, then turning the crossbars in the second rotational direction 58 will increase the tension. This operation may be performed when securing containers on a container ship prior to transport so that the container do not shift during transport.

FIG. 4B is a perspective view of the tool 10 in position to manipulate a lashing bar turnbuckle 50 (only the turnbuckle body is shown; the fittings are omitted) using the fork 30 of the tool 10. The first prong 34 is positioned on one side of the crossbars 51, 52, and the second prong 36 is positioned on the other side of the crossbars 51, 52. However, the width and depth of the slot 31 must be large enough to receive both crossbars 51, 52, but the width of the slot 31 (i.e., the distance between the prongs 34, 36) must also be narrow enough to be able to turn the crossbars 51, 52. So, the slot width must be greater than the thickness (“T₂”) of a single crossbar (i.e., the narrow dimension of the turnbuckle body profile) but less than the width (“W₂”) of the entire turnbuckle 50 (i.e., the wider dimension of the turnbuckle body profile). The slot width is preferably only slightly larger than the thickness of a single crossbar, such that there is very little slack therebetween. Applying a force in the second rotational direction 58 relative to the axis 60 of the turnbuckle 50 will cause the turnbuckle 50 to tighten a connected lashing bar (not shown). However, the direction of rotation that will cause tightening or loosening of the turnbuckle may be changed by reversing the orientation of the turnbuckle.

FIG. 4C is a perspective view of the tool 10 in position to manipulate a lashing bar turnbuckle 50 (only partially shown) using the paddle 40 of the tool 10. The paddle 40 has been inserted between the crossbars 51, 52 such that rotation of the tool 10 about the axis 60 of the turnbuckle 50 causes the textured and concave surfaces 42, 44 to contact the inner surfaces of the crossbars 51, 52. Further rotation of the tool 10 under a rotational force applied by a user to the far end 21 of the shaft 20 or even to the fork 30 causes rotation of the crossbars 51, 52 of the turnbuckle 50. As previously described, rotation in one direction will cause contraction of the fittings (not shown; see FIG. 4A) and an increase in tension whereas rotation in the opposite direction will cause separation of the fittings and a decrease in tension. The tool 10 enables the user to engage the turnbuckle 50 either inside or outside the turnbuckle crossbars 51, 52 depending on what is best for a particular scenario considering physical constraints near the turnbuckle 50.

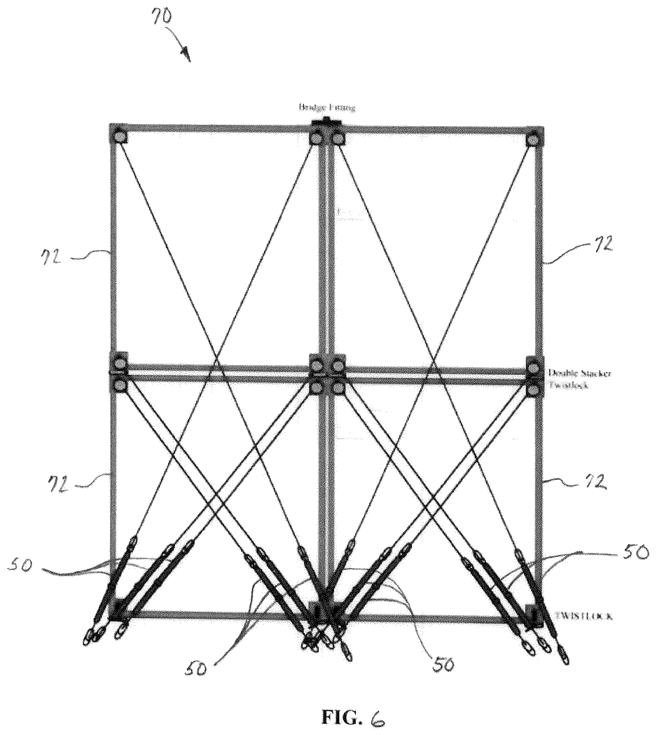

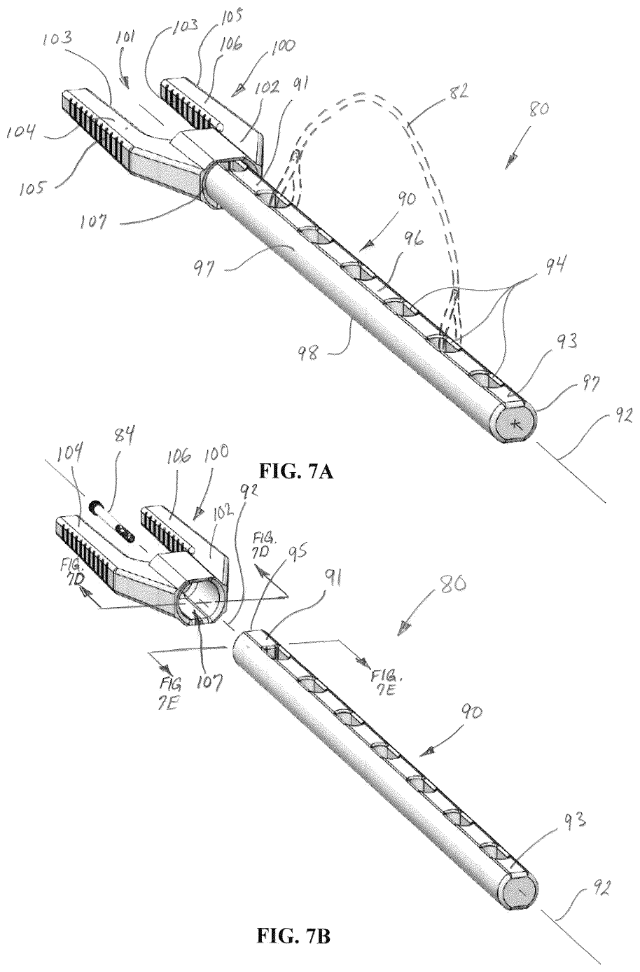

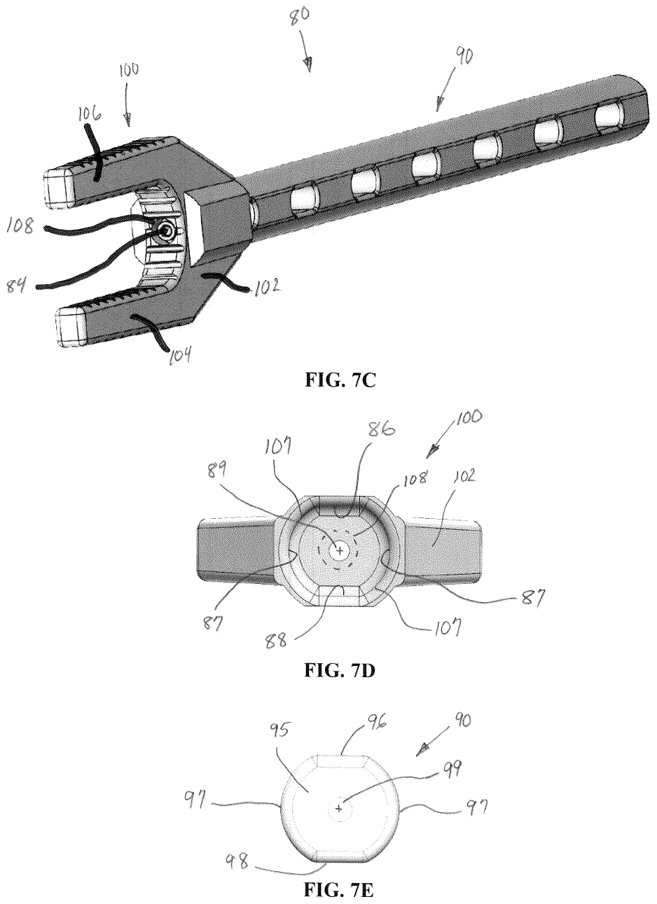

It should be understood that the tool 10 and/or the tool 80 shown later in FIG. 7A may be used in other ways not specifically shown. For example, in a manner similar to the use of the paddle 40 in FIG. 4C, a turnbuckle might also be turned or rotated using the fork 30 of tool 10, the fork 100 of tool 80, or the shaft end 93 of the tool 80 positioned between the turnbuckle crossbars 51, 52. With regard to the use of a fork 30, 100 between the turnbuckle crossbars 51, 52, the fork 30, 100 may be turned so that both prongs are inserted between the turnbuckle crossbars 51, 52 or a single prong of the fork 30, 100 may be inserted between the turnbuckle crossbars 51, 52.

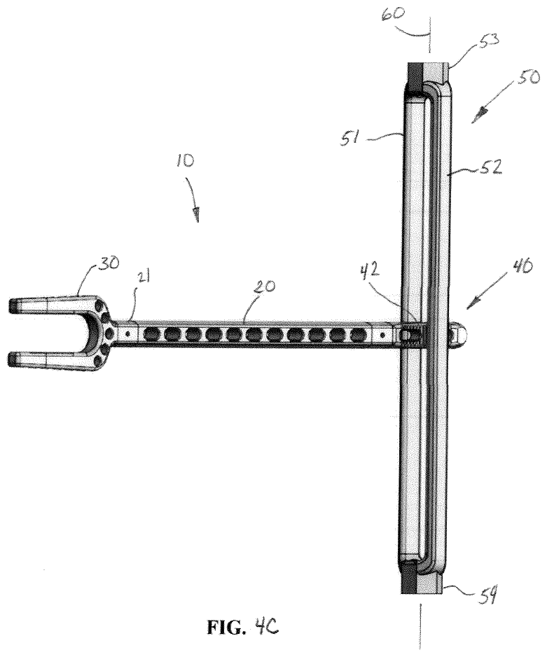

FIG. 5 is a manufacturing diagram of the tool 10 identifying some preferred dimensions according to one embodiment. In this non-limiting example, the overall length of the tool 10 when configured with a shaft 20 and two end effectors 30, 40 is about 33 inches (32.94 inches). In reference to the first end effector (fork) 30, the overall width of the fork is about 4 inches (3.90 inches) and the width of the slot 31 between the prongs 34, 36 is about 2 inches. Furthermore, the thickness of the shaft 20, and each end effector 30, 40 is about 1 inch (1.06 inch). An outer radius of curvature on the sides of the shaft and the second end effector is about 0.7 inch (0.69 inch radius)

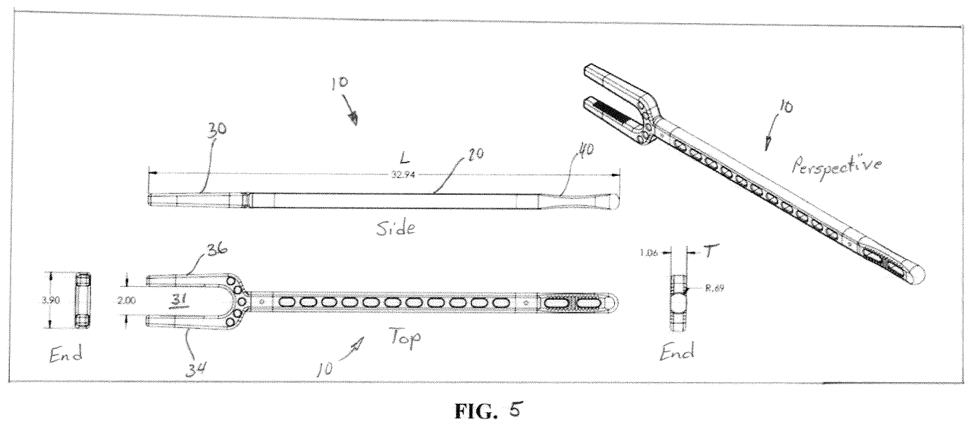

FIG. 6 is a diagram showing a container storage configuration 70 including the ends of four storage containers 72 and twelve lashing bar turnbuckles 50 being used to secure the four storage containers. Due to the close proximity of adjacent turnbuckles 50 and the potential presence of multiple workers in the same space, the size and configuration of the tool 10 is important. Furthermore, the turnbuckles 50 are positioned very close to the ends of the containers 72, such that the turnbuckles 50 can only be accessed from one side. These limitations are further complicated by the practicality that the crossbars of each turnbuckle 50 may be at different angles. Therefore, it is a technical advantage of the tool 10 that there are different end effector types, such as a frame and a paddle, at the ends of the tool 10 to give the worker two options for engaging, gripping and turning each turnbuckle 50.

FIGS. 7A-C are perspective views of a tool 80 for manipulating a lashing bar turnbuckle (not shown; but see FIGS. 4A-C) according to a second embodiment. The tool 80 includes an elongate rigid shaft 90, a fork 100 on a first end of the shaft 90. The elongate rigid shaft 90 has a central axis 92, a first end 91 and a second end 93. The elongate rigid shaft 20 is shown with an optional series of holes or cut-outs 94 (7 elongate holes shown). The elongate rigid shaft 90 is also shown having an optional flattened top face 96 and an optional identical flattened bottom face 98 parallel to the top face 26. The opposing lateral edges 97 between the top and bottom faces 26, 28 have a curved convex profile.

The fork 100 is connected to the first end 21 of the shaft 90. The fork 100 includes a base member or section 92 that connects to the shaft 90, a first prong 104 extending distally from the base section or member 102, and a second prong 106 extending distally from the base section 102. The space between the first and second prongs 104, 106 forms a slot or space 101 for receiving the crossbars of a turnbuckle. In one option, the first and second prongs 104, 106 have inwardly facing surfaces 103 that are textured and/or coated to increase their grip (i.e., slip resistance) when contacting the turnbuckle crossbars. Furthermore, the outward facing surfaces 105 may also be textured and/or coated to resist slipping when engaging a component or structure.

The fork 100 further includes a socket 107 formed in middle of the base section 102. The cross-sectional shape or profile of the socket 107 should be complementary to cross-sectional shape or profile of the shaft 90 so that the socket 107 and shaft 90 form a mating connection that is stable and strong. The complementary cross-sectional shapes or profiles of the socket 107 and shaft 90 are preferably non-circular so that the shaft 90 is unable to rotate about its axis 92 within the socket 107. The mating connection is also preferably close-fitting or snug to prevent angular deflection between the fork 100 and the shaft 90. In other words, the mating connection should cause the shaft 90 and the socket 107 to move together as if they were integrally formed. When the fork 100 is engaged with a turnbuckle, a user may rotate the turnbuckle by applying a rotational force to the second end 93 of the shaft 90 or any end effector secured to the second end.

An optional carrying strap 82 is illustrated (dashed lines) attached to the shaft 90 of the tool 80. First and second ends of the strap 82 may each form a loop that extends through one of the holes 94. In one option, the strap 82 may be made from strong, synthetic fibers, such as polyester, nylon, or polypropylene, that are woven into a durable webbing. The strap 82 may facilitate storage and/or hands-free carrying of the tool 80.

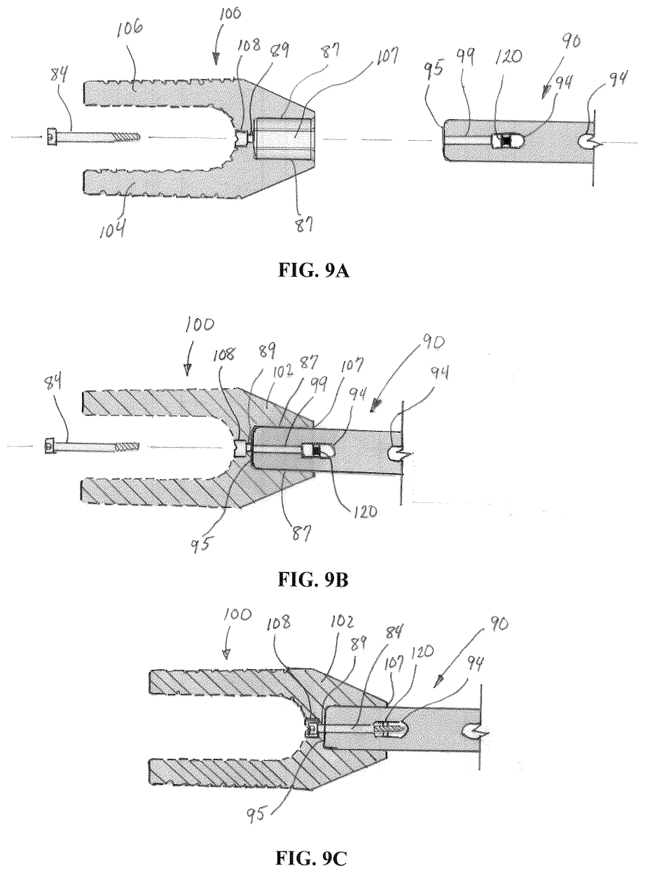

FIG. 7B is an exploded perspective view of the tool 10. In this view, the first and second ends 91, 93 of the shaft 90 are shown to form a plug 95 that is axially aligned with the socket 107 of the fork 100. Each end 91, 93 of the shaft 90 may form a plug, such that the socket 107 of the fork 100 may be interchangeably connected to either end of the shaft 90. Accordingly, inserting the plug 95 (end of the shaft 90) into the socket 107 of the fork 100 allows the configuration of the tool 10 as shown in FIG. 7A. Preferably, a fastener such as a bolt 12 may be secured through the wall of the socket and into the plug 95. The use of a fastener is shown in more particularity in reference to FIGS. 9A-C.

FIG. 7C is a perspective view of the fully assembled tool 80 as in FIG. 7A for manipulating a lashing bar turnbuckle (not shown; but see FIGS. 4A-C) according to a second embodiment. The tool 80 shows the head of the bolt 84 within a cylindrical counterbore in the base section 102. Passing the shaft of the bolt 84 through a hole in the center of the cylindrical counterbore 108 and threadably connecting the bolt 84 to the plug in the shaft 90 will cause the head of the bolt 84 to bear against a shoulder formed between the counterbore 108 and the hole and pull the base section 102 firmly against the end of the shaft 90.

FIG. 7D is a proximal end view of the socket 107 formed in the fork 100 according to the second embodiment. FIG. 7D and FIG. 7E should be viewed together to appreciate the complementary shapes of the socket 107 in FIG. 7D and the shaft 90 in FIG. 7E. The socket 107 has flat top and bottom surfaces 86, 88 corresponding to the flat top and bottom surfaces 96, 98 of the shaft 90. Furthermore, the socket 107 has opposing curved side surfaces 87 corresponding to the curved side surfaces 97 of the shaft 90. Accordingly, the shaft 90 will fit closely or snuggly within the socket 107. Still further, the socket 107 includes a bolt hole 89 that is centered within the socket 107 and centered within the counterbore 108

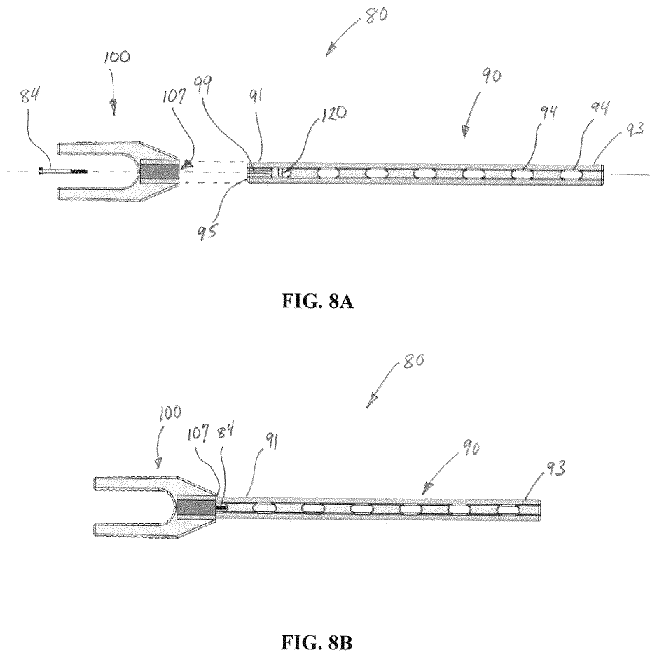

FIG. 7E is an end (profile) view of the shaft 90 to be received into the socket 107 formed in the fork 100 according to the second embodiment. The profile of the shaft 90 has a flat top surface 96, a flat bottom surface 98 and opposing convex curved side surfaces 97. The end of the shaft 90 forms a plug 95 with a centered hole 99, which should align with the hole 89 in the socket 107 when the plug 95 is received into the socket 107. The centered hole 99 may be a threaded hole for engaging the threads of the bolt 84 after the shank of the bolt is passed through the hole 89 in the socket 107. Alternatively, the centered hole 99 may be a through-hole leading to a nut disposed in one of the holes or cutouts 94 (as shown in FIG. 8A and FIGS. 9A-C). Note that the complementary profiles (shape and size) of the socket 107 and plug 95 at the end of the shaft 90 prevent angular deflection and rotation therebetween.

FIGS. 8A-B include an assembly view and a fully assembled view of the tool 80 according to the second embodiment. In FIG. 8A, the axial centerlines of the threaded bolt 84, the socket 107, the shaft 90 and a threaded nut 120 are aligned for forming a mating connection. Furthermore, the shaft 90 is rotationally oriented so that the non-circular shape or profile of the plug 95 will be received into the socket 107. In FIG. 8B, the plug 95 has been inserted into the socket 107, the bolt 84 has been inserted through a wall of the socket 107 and into the plug 95, and the bolt 84 has been threadably secured into the nut 120. Accordingly, the bolt 84 and nut 120 prevent the plug 95 from pulling out of the socket 107. Note that the head of the bolt 84 cannot be seen in FIG. 8B because it has been received into the counterbore.

FIGS. 9A-C are cross-sectional views illustrating the stepwise formation of a mating connection between the fork 100 and the shaft 90 according to the second embodiment. In FIG. 9A, the bolt 83 is aligned with the counterbore 108, the centered hole 89, and the socket 107. Similarly, the plug 95 formed by the end of the shaft 90 along with the centered hole 99 and the threaded nut 120 are also aligned with the socket 107.

In FIG. 9B, the end or plug 95 of the shaft 90 has been inserted and seated in the socket 107. Notice that the centered hole 89 in the base section 102 of the fork 100 is aligned with the centered hole 99 in the end of the shaft 90. The complementary profiles of the shaft 90 and the socket 107 should be snug and prevent angular deflection and axial rotation of the shaft 90 relative to the fork 100 during use. The purpose of the bolt 84 is to prevent the end of the shaft 90 from pulling out of the socket 107.

In FIG. 9C, the bolt 84 has been inserted through the counterbore 108, the centered hole 89 in the base section 102, and the centered hole 99 in the shaft 90 before a threaded portion of the bolt 84 has been rotationally threaded into the threaded nut 120. Because the head of the bolt 84 seats against a shoulder between the counterbore 108 and the centered hole 89, and because the threaded nut 120 is not able to pull through the centered hole 99 and/or is welded within the hole 94, tightening the threads on the bolt 84 into the nut 120 will create a force pulling the shaft 90 into the socket 107.

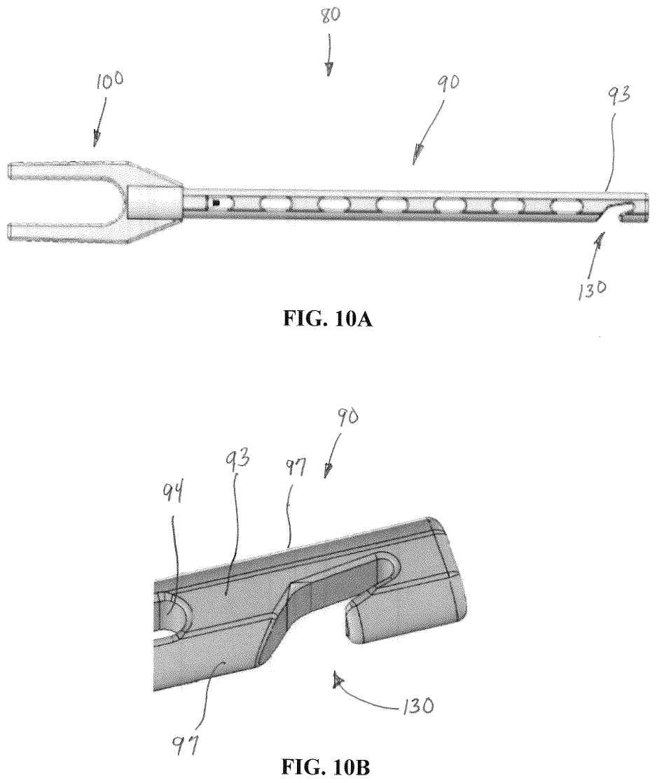

FIGS. 10A-B are side and perspective views of a proximal end 93 of the shaft 90 including an optional hook 130 according to some embodiments. In this example, the hook 130 is integrated into the shaft 90 and is formed within the profile of the shaft 90. The hook 130 opens to one of the curved sides 97. The exact shape and size of the hook 130 may be customized for a particular purpose, such as to engage a latch on a container twist lock. The length of the tool 80 makes it easier to reach and manipulate the latch to apply or release the container twist lock.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but are not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A tool, comprising:
an elongate rigid shaft having a first end and a second end, wherein the first end of the shaft forms a first connector element;
a fork having a base section, first and second prongs extending distally from the base section, and a second connector element formed with the base section, where the second connector element is configured to form a mating connection with the first connector element, and wherein the first and second connector elements have complementary non-circular circumferential profiles configured for one of the connector elements to fit closely within another of the connector elements and prevent angular deflection and axial rotation between the connector elements.

2. The tool of claim 1, wherein the first and second connector elements include a socket and a plug, and wherein the plug is axially inserted into the socket and secured within the socket using a fastener that extends laterally through a side wall of the socket and into a side of the plug.

3. The tool of claim 1, wherein the first and second connector elements include a socket and a plug, and wherein the plug is axially inserted into the socket and secured within the socket using a fastener that extends axially through a distal end of the socket and into a distal end the plug.

4. The tool of claim 1, wherein the elongate rigid shaft and the fork are each machined from aircraft grade aluminum.

5. The tool of claim 1, further comprising:
a hook positioned at the second end of the shaft.

6. The tool of claim 1, wherein the fork is adapted for securely engaging and rotating a turnbuckle body of a turnbuckle, and wherein the elongate rigid shaft forms a lever for turning the turnbuckle body.

7. The tool of claim 6, wherein the first and second prongs having inward-facing surfaces that are textured to resist slippage when engaging the turnbuckle body.

8. The tool of claim 6, wherein the turnbuckle is a lashing bar turnbuckle on a container ship.

9. The tool of claim 6, wherein the first and second prongs have a length extending from the base section that is greater than a width of a space between the first and second prongs.

10. The tool of claim 9, wherein the width of the space between the first and second prongs is greater than a narrow profile dimension of the turnbuckle body and the length of the first and second prongs from the base section is greater than a wide profile dimension of the turnbuckle body.

11. The tool of claim 9, wherein the first and second prongs will receive the turnbuckle body into the space therebetween only when a lateral axis between the pair of turnbuckle crossbars is aligned with a central axis of an opening into the space between the first and second prongs.

12. The tool of claim 11, wherein, with the turnbuckle body received between the first and second prongs, rotation of the fork causes the first and second prongs to bear on the outside of the turnbuckle body and cause rotation of the turnbuckle body.

13. The tool of claim 1, further comprising:
a paddle positioned at the second end of the shaft, wherein the paddle is adapted for positioning between a pair of turnbuckle crossbars of a turnbuckle and, with the paddle positioned between the pair of turnbuckle crossbars, rotation of the paddle causes the paddle to bear on the inside of the turnbuckle crossbars and cause rotation of the turnbuckle body, and wherein the elongate rigid shaft forms a lever for turning the turnbuckle body.

14. The tool of claim 13, wherein the paddle has first and second opposing surfaces that each form a concave recess that is textured to resist slippage when positioned between the pair of turnbuckle crossbars.

15. The tool of claim 1, wherein the elongate rigid shaft includes a series of through-holes along an axial length of the elongate rigid shaft.

16. The tool of claim 15, further comprising:
a carrying strap having first and second loops secured through two of the through-holes in the elongate rigid shaft.

17. The tool of claim 15, wherein the base section of the fork includes a least one through-hole.

18. The tool of claim 1, wherein the elongate rigid shaft includes first and second opposing flat side faces that are parallel, and wherein the fork includes first and second opposing flat side faces that are parallel.

19. The tool of claim 18, wherein the elongate rigid shaft includes a series of through-holes along an axial length of the elongate rigid shaft, and wherein the series of through-holes each extend through the elongate rigid shaft perpendicular to the first and second opposing flat side faces.

20. The tool of claim 19, wherein the elongate rigid shaft includes opposing lateral edges extending between the first and second opposing flat side faces, wherein the opposing lateral edges each have a convex curved profile.
